(19) United States
(12) Patent Application Publication
(10) Pub. No.: US 2025/0286247 A1
(43) Pub. Date: Sep. 11, 2025

(54) LAMINATED BATTERY AND METHOD FOR MANUFACTURING LAMINATED BATTERY

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/964,110

(22) Filed: Nov. 29, 2024

(30) Foreign Application Priority Data
Mar. 6, 2024 (JP) 2024-034117

(51) Int. Cl. H01M 50/54; B23K 11/11; H01M 50/528; H01M 50/533; H01M 50/536

(52) U.S. Cl. CPC H01M 50/54; B23K 11/115; H01M 50/528; H01M 50/533; H01M 50/536

(57) ABSTRACT

In the laminated battery, the current collector terminal has one slit portion on a part of a surface facing the electrode laminate, all of the plurality of current collector foils are collected to form a collected foil portion, and the collected foil portion is inserted and joined to the slit portion, whereby the electrode laminate is electrically connected to the current collector terminal via the current collector foils. The method for manufacturing a laminated battery includes inserting a collected foil portion into a slit portion of a current collector terminal, disposing resistance welding electrodes on both sides of the current collector terminal so as to sandwich the slit portion, energizing the resistance welding electrode while pressing the current collector terminal with the resistance welding electrode, and resistance welding the current collector foil in the slit portion, and accommodating the electrode laminate with the current collector terminal and the exterior body.

### CROSS-REFERENCE TO RELATED APPLICATION

This application claims priority to Japanese Patent Application No. 2024-034117 filed on Mar. 6, 2024, incorporated herein by reference in its entirety.

### BACKGROUND

### 1. Technical Field

The present disclosure relates to a laminated battery and a method for manufacturing the laminated battery.

### 2. Description of Related Art

There is known a laminated battery including an electrode laminate, a current collector terminal, and an exterior body that houses the electrode laminate together with the current collector terminal.

For example, Japanese Unexamined Patent Application Publication No. 2023-084066 (JP 2023-084066 A) discloses a secondary battery that is a laminated battery as described above, in which a current collector (current collector foil) is joined to a surface of a lid terminal (current collector terminal) that faces a power generation element (electrode laminate), thereby electrically connecting the current collector terminal and the lid terminal. In this case, JP 2023-084066 A discloses, in particular, that the structural efficiency can be improved by electrically connecting a plurality of current collectors to the lid terminal in a curved state.

JP 2023-084066 A also discloses a secondary battery that includes at least one current collector and in which the inner surface of the lid terminal has at least one slit portion and the current collector and the lid terminal are electrically connected by disposing the current collector in the slit portion. In this case, JP 2023-084066 A discloses, in particular, that a smaller number of current collectors disposed in one slit portion is preferable and one current collector disposed in one slit portion is most preferable from the viewpoint of improving the structural efficiency.

JP 2023-084066 A further discloses that cutting of the current collector due to movement of the power generation element along with an external impact can be suppressed by integrating the members with a resin provided in the exterior portion (exterior body).

### SUMMARY

When the current collector foil and the current collector terminal are joined together, it is desirable to achieve both improvement in structural efficiency and suppression of cutting of the current collector foil.

An object of the present disclosure is to provide a laminated battery that achieves both improvement in structural efficiency and suppression of cutting of a current collector foil, and a method for manufacturing such a laminated battery.

The inventors of the present disclosure have found that the above issue can be addressed by the following means.

### First Aspect

A laminated battery includes:
an electrode laminate;
a current collector terminal; and
an exterior body that houses the electrode laminate together with the current collector terminal.
A plurality of current collector foils extends from an end face of the electrode laminate. The current collector terminal has one slit portion in part of a surface that faces the electrode laminate, all the current collector foils are collected into a collected foil portion, and the collected foil portion is inserted into and joined to the slit portion to electrically connect the electrode laminate to the current collector terminal via the current collector foils.

### Second Aspect

In the laminated battery according to the first aspect, a depth of the slit portion may be 30% or more of a thickness of the current collector terminal.

### Third Aspect

A method for manufacturing the laminated battery according to the first or second aspect includes:
providing the electrode laminate and the current collector terminal;
inserting the collected foil portion into the slit portion of the current collector terminal; disposing resistance welding electrodes on both sides of the current collector terminal to sandwich the slit portion;
performing resistance welding on the current collector foils in the slit portion by energizing the resistance welding electrodes while pressing the current collector terminal with the resistance welding electrodes; and
housing the electrode laminate in the current collector terminal and the exterior body.

According to the present disclosure, it is possible to provide the laminated battery that achieves both improvement in structural efficiency and suppression of cutting of the current collector foil, and the method for manufacturing such a laminated battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a laminated battery of the present disclosure in the laminated battery of the present disclosure;

FIG. 2A is a schematic diagram illustrating a method of manufacturing a laminated battery according to an embodiment of the present disclosure;

FIG. 2B is a schematic diagram illustrating a method of manufacturing a laminated battery according to an embodiment of the present disclosure;

FIG. 2C is a schematic diagram illustrating a method of manufacturing a laminated battery according to an embodiment of the present disclosure; and

FIG. 2D is a schematic diagram illustrating a method of manufacturing a laminated battery according to an embodiment of the present disclosure.

### DETAILED DESCRIPTION OF EMBODIMENTS

Hereinafter, embodiments of the present disclosure will be described in detail with reference to the drawings. It should be noted that the present disclosure is not limited to the following embodiments, and various modifications can be made within the scope of the gist of the disclosure. In addition, the dimensional relationship in the drawings does not reflect the actual dimensional relationship.

### Laminated Battery

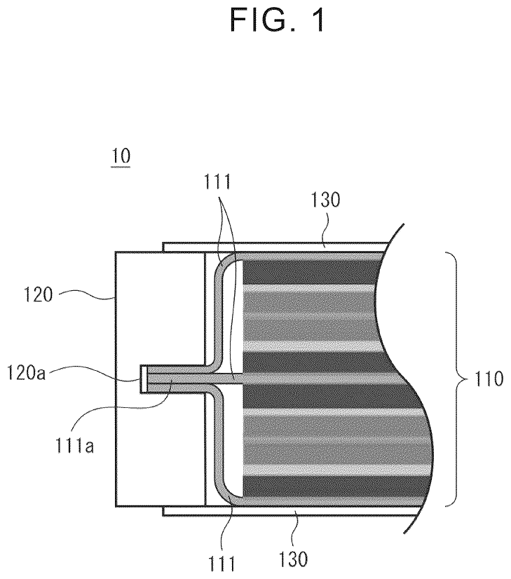

As illustrated in FIG. 1, a laminated battery 10 of the present disclosure includes an electrode laminate 110, a current collector terminal 120, and an exterior body 130 that houses the electrode laminate together with the current collector terminal. In the laminated battery of the present disclosure, a plurality of current collector foils 111 extend from an end face of the electrode laminate. In the laminated battery of the present disclosure, the current collector terminal has one slit-portion 120a on a part of a surface facing the electrode laminate, and all of the plurality of current collector foils are collected to form a collected foil portion 111a. Further, the collected foil portion is inserted into and joined to the slit portion, whereby the electrode laminate is electrically connected to the current collector terminal via the plurality of current collector foils.

As illustrated in FIG. 1, in the present disclosure, the current collector foil 111 as a collected foil portion 111a is bonded to the inside of the slit-portion 120a of the current collector terminal 120. As a result, it has been found that the distance between the electrode laminate 110 and the current collector terminal 120 can be shortened, and thus the structural efficiency of the battery can be improved. Further, as illustrated in FIG. 1, the Disclosing Party and others have found that cutting of the current collector foil 111 can be suppressed by collecting all of the plurality of current collector foils 111.

The laminated battery of the present disclosure may be, for example, a lithium-ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving of hybrid electric vehicle (HEV), plug-in hybrid electric vehicle (PHEV), or battery electric vehicle (BEV). Also, the battery in the present disclosure may be used as a power source for mobile bodies other than vehicles (for example, railroads, ships, and aircraft), and may be used as a power source for electric products such as an information processing device.

Hereinafter, elements constituting the laminated battery 10 of the present disclosure will be described.

### Electrode Laminate

As illustrated in FIG. 1, a laminated battery 10 of the present disclosure includes an electrode laminate 110. The electrode laminate functions as a power generation element of the battery.

In the electrode laminate 110, a plurality of current collector foils 111 extend from an end face of the electrode laminate. In addition, all of the plurality of collector foils are collected to form a collected foil portion 111a.

The electrode laminate may include a negative electrode current collector layer, a negative electrode active material layer, a solid electrolyte layer, a positive electrode active material layer, and a positive electrode current collector layer in this order. The electrode laminate may be formed by stacking a plurality of laminated battery units 100 each having a positive electrode current collector layer, a positive electrode active material layer, a solid electrolyte layer, a negative electrode active material layer, a negative electrode current collector layer, a negative electrode active material layer, a solid electrolyte layer, a positive electrode active material layer, and a positive electrode current collector layer in this order. Here, the plurality of current collector foils 111 forming the collected foil portion 111a may be the positive electrode current collector layer or the negative electrode current collector layer. Note that the positive electrode current collector layer may be shared between the laminated battery units.

The number of the current collector foils 111 extending from the end face of the electrode laminate 110 is not particularly limited. The smaller the number, the smaller the space required for collecting the plurality of current collector foils 111, and thus the structural efficiency of the battery can be improved. The larger the number, the higher the strength of the current collector foil 111, and thus it is possible to effectively suppress the cutting of the current collector foil 111.

The length, thickness, and the like of the current collector foil 111 extending from the end face of the electrode laminate 110 are not particularly limited, and can be appropriately set in view of, for example, the structural efficiency of the battery, the strength of the current collector foil, the ease of inserting and joining 111a of the collector foil into the slit-portion 120a, and the like.

The thickness, shape, size, and the like of the electrode laminate 110 are not particularly limited, and can be appropriately set in accordance with the use of the laminated battery and the like.

The number of the laminated battery units 100 is not particularly limited, and can be appropriately set in accordance with the use of the laminated battery.

Hereinafter, each member that can constitute the electrode laminate according to the present disclosure will be described.

In order to facilitate understanding of the present disclosure, each member of the electrode laminate of the lithium ion secondary battery which is a solid-state battery is described as an example, but the laminated battery of the present disclosure is not limited to the lithium ion secondary battery. In the context of the present disclosure, a “solid state battery” means a battery that uses at least a solid electrolyte as an electrolyte, and therefore a solid state battery may use a combination of a solid electrolyte and a liquid electrolyte as an electrolyte. The solid-state battery of the present disclosure may be an all-solid-state battery, that is, a battery using only a solid electrolyte as an electrolyte.

### Positive Electrode Current Collector Layer

The conductive material used for the positive electrode current collector layer is not particularly limited, and may be, for example, SUS, aluminum, copper, nickel, iron, titanium, carbon, or the like.

The shape of the positive electrode current collector layer is not particularly limited, and examples thereof include a foil shape, a plate shape, and a mesh shape. Among the above, the foil shape is preferred.

The positive electrode current collector layer may extend from an end face of the electrode laminate, and a plurality of positive electrode current collector layers may be collected and foiled in the extending portion. In particular, all of the plurality of positive electrode current collector layers may be collected to form a collected foil portion.

### A Cathode Active Material Layer Including

The positive electrode active material layer includes at least a positive electrode active material, and preferably further includes a solid electrolyte described later. In addition, an additive used in a positive electrode active material layer of a solid battery, such as a conductive auxiliary agent or a binder, may be included in accordance with the use purpose, the use purpose, and the like.

The material of the positive electrode active material is not particularly limited. For example, the positive electrode active material may be lithium cobaltate (LiCoO₂), lithium nickelate (LiNiO₂), lithium manganate (LiMn₂O₄), Li_{1.5}Co_{1/3}Ni_{1/3}Mn_{1/3}O₂, LiCo_{1/3}Ni_{1/3}Mn_{1/3}O₂, a heterogeneous element-substituted Li—Mn spinel having a composition represented by Li₁₊ₓMn_{2-x-y}M_{y}O₄ (M is at least one metal element selected from among Al, Mg, Co, Fe, Ni, and Zn), or the like.

The conductive aid is not particularly limited. For example, the conductive auxiliary agent may be a carbon material such as VGCF (vapor deposition carbon fiber, Vapor Grown Carbon Fiber), carbon nanofiber, or the like, or a metallic material.

The binder is not particularly limited. For example, the binder may be a material such as polyvinylidene fluoride (PVdF), carboxymethylcellulose (CMC), butadiene rubber (BR) styrene butadiene rubber (SBR), or a combination thereof.

### Solid Electrolyte Layer

The solid electrolyte layer contains at least a solid electrolyte. The solid electrolyte is not particularly limited, and a material that can be used as a solid electrolyte of a solid battery can be used. For example, the solid electrolyte may be a sulfide solid electrolyte, an oxide solid electrolyte, a polymer electrolyte, or the like.

Examples of sulfide solid electrolytes include, but are not limited to, sulfide-based amorphous solid electrolytes, sulfide-based crystalline solid electrolytes, argyrodite-type solid electrolytes, and the like. Specific examples of sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

Example of the oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi_{2- x}(PO₄)₃, Li₁₊ₓAlₓGe₂₋ₓ(PO₄)₃, Li₃PO₄, Li₃₊ₓPO₄₋ₓNₓ(LiPON), and the like.

Examples of polymer electrolytes include, but are not limited to, polyethylene oxide (PEO), polypropylene oxide (PPO), and the like, and copolymers thereof.

The solid electrolyte may be glass or crystallized glass (glass ceramic). In addition, the solid electrolyte layer may contain a conductive auxiliary agent, a binder, or the like as necessary in addition to the above-described solid electrolyte. For the conductive assistant and the binder, reference can be made to the above description of the positive electrode active material layer.

### Negative Electrode Active Material Layer

The negative electrode active material layer includes at least a negative electrode active material, and preferably further includes the above-described solid electrolyte. In addition, an additive used in a negative electrode active material layer of a solid battery, such as a conductive auxiliary agent and a binder, may be included in accordance with the use purpose, the use purpose, and the like.

The material of the negative electrode active material is not particularly limited, and is preferably capable of occluding and releasing metal ions such as lithium ions. For example, the negative electrode active material may be an oxidation-based negative electrode active material, an alloy-based negative electrode active material, a carbon material, or the like, but is not limited thereto.

The oxidized negative electrode active material is not particularly limited, and examples thereof include lithium titanate (LTO) grains.

The alloy-based negative electrode active material is not particularly limited, and examples thereof include a Si alloy-based negative electrode active material, a Sn alloy-based negative electrode active material, and the like. Examples of the Si alloy-based negative electrode active material include silicon, silicon oxide, silicon carbide, silicon nitride, and solid solutions thereof. In addition, the Si alloy-based negative electrode active material can contain elements other than silicon, such as Fe, Co, Sb, Bi, Pb, Ni, Cu, Zn, Ge, In, Sn, and Ti. Examples of the Sn alloy-based negative electrode active material include tin, tin oxide, tin nitride, and solid solutions thereof. In addition, the Sn alloy-based negative electrode active material can contain elements other than tin, such as Fe, Co, Sb, Bi, Pb, Ni, Cu, Zn, Ge, In, Ti, and Si.

The carbon material is not particularly limited, and examples thereof include hard carbon, soft carbon, and graphite.

For the solid electrolyte used in the negative electrode active material layer, reference can be made to the above description regarding the solid electrolyte layer, and for the conductive auxiliary agent and the binder, reference can be made to the above description regarding the positive electrode active material layer.

### Negative Electrode Current Collector Layer

The conductive material used for the negative electrode current collector layer is not particularly limited, and may be, for example, SUS, aluminum, copper, nickel, iron, titanium, carbon, or the like, but is not limited thereto.

The shape of the negative electrode current collector layer is not particularly limited, and examples thereof include a foil shape, a plate shape, and a mesh shape. Among the above, the foil shape is preferred.

The negative electrode current collector layer may extend from an end face of the electrode laminate, and a plurality of negative electrode current collector layers may be collected in the extending portion. In particular, all of the plurality of negative electrode current collector layers may be collected to form a collected foil portion.

### Current Collector Terminal

As illustrated in FIG. 1, the laminated battery 10 of the present disclosure includes a current collector terminal 120. The current collector terminal 120 houses the electrode laminate 110 together with the exterior body 130. The current collector terminal may be disposed so as to face a pair of end faces of the electrode laminate.

The shape of the current collector terminal is not particularly limited except that the current collector terminal has a slit portion to be described later, but the current collector terminal may have a peripheral surface adjacent to a surface facing the electrode laminate.

The size, material, and the like of the current collector terminal are not particularly limited, and can be appropriately set in accordance with the use of the laminated battery or the like. For example, the material of the current collector terminal may be a metallic material, in particular stainless steel or aluminum.

### Slit Portion

As illustrated in FIG. 1, the current collector terminal 120 has one slit-portion 120a on a part of a surface facing the electrode laminate 110. Foil collecting portion 111a is inserted and joined to the slit portion 120a. Thus, the electrode laminate 110 is electrically connected to the current collector terminal 120 via the plurality of current collector foils 111.

The depth of the slit-portion 120a may be 30% or more of the thickness of the current collector terminal 120. The depth of the slit-portion 120a may be 40% or more, 50% or more, or 60% or more of the thickness of the current collector terminal 120, and may be 100% or less, 90% or less, 80% or less, 70% or less, 60% or less, or 50% or less. When the depth of the slit portion 120a is 100% of the thickness of the current collector terminal 120, this means that the slit portion 120a passes through the current collector terminal 120. The thickness of the current collector terminal 120 refers to the length of the slit portion 120a in the depth direction, that is, the direction in which the slit portion 120a extends.

The slit portion may be formed in a central portion of a surface facing the electrode laminate. With such a configuration, the space required for collecting the current collector foil can be reduced, and thus the structural efficiency of the battery can be improved.

The slit portion may be formed parallel to the surface direction of the electrode laminate.

The shape, size, thickness, and the like of the slit portion are not particularly limited, and can be appropriately set in consideration of ease of insertion and joining of the foils into the slit portion.

### Exterior Body

The laminated battery 10 of the present disclosure includes an exterior body 130. The exterior body 130 houses the electrode laminate 110 together with the current collector terminal 120. The exterior body may be bonded to the peripheral surface of the current collector terminal, and thus may house the electrode laminate together with the current collector terminal.

As the exterior body, a laminate film is exemplified. The laminate film may include a sealant resin layer, a metal layer, and a protective resin layer in this order along the thickness direction. Examples of the sealant resin include olefin-based resins such as polypropylene (PP) and polyethylene (PE). Examples of the material of the metal layer include aluminum, aluminum alloy, and stainless steel. Examples of the material of the protective resin layer include polyethylene terephthalate (PET) and nylon.

The thickness of each layer constituting the laminate film and the thickness of the laminate film are not particularly limited. The thickness of the sealant resin layer is, for example, 40 μm or more and 100 μm or less. The thickness of the metal layer is, for example, 30 μm or more and 60 μm or less. The thickness of the protective resin layer is, for example, 20 μm or more and 60 μm or less. The thickness of the laminate film is, for example, 80 μm or more and 250 μm or less.

### Method for Manufacturing Laminated Battery

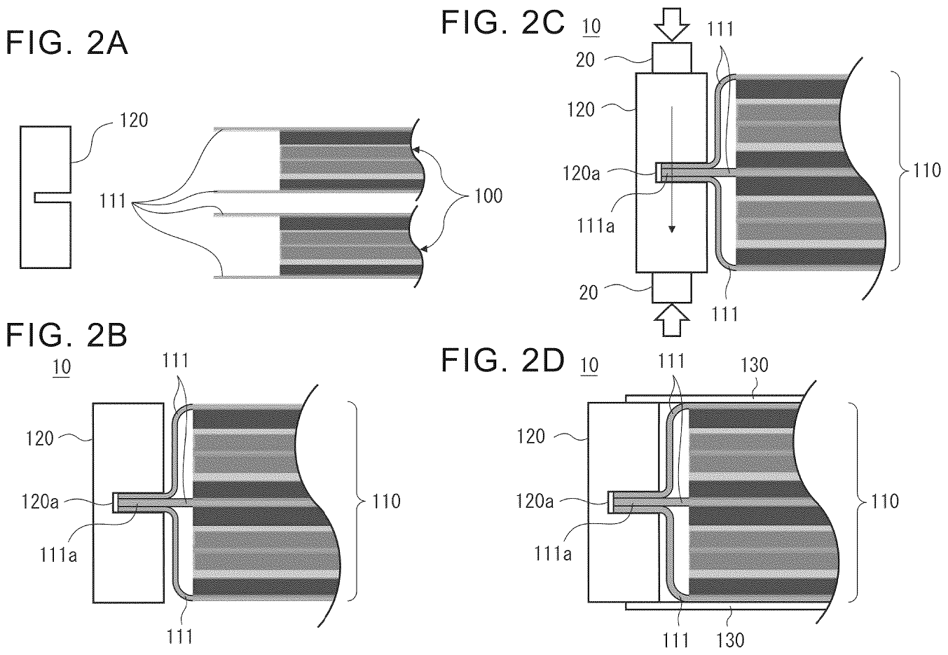

As illustrated in the FIG. 2A to FIG. 2D, the disclosed methods of fabricating the laminated battery 10 include the following steps:

Providing the electrode laminate 110 and the current collector terminal 120, in the slit portion 120a of the current collector terminal, inserting the collected foil portion 111a, so as to sandwich the slit portion, to place the resistance welding electrode 20 on both sides of the current collector terminal, while pressing the current collector terminal with the resistance welding electrode, energizing the resistance welding electrode, to the current collector foil in the slit portion, and to accommodate the electrode laminate in the current collector terminal and the exterior body 130.

By manufacturing the laminated battery 10 by such a method, it is possible to obtain a laminated battery in which both improvement in structural efficiency and suppression of cutting of the current collector foil 111 are achieved

Hereinafter, each step in the method of the present disclosure will be described.

### Electrode Laminate and Current Collector Terminal Providing Process

As illustrated in FIG. 2A, the disclosed methods include providing an electrode laminate 110 and a current collector terminal 120.

The method of providing the electrode laminate is not particularly limited. For example, an electrode laminate can be provided by laminating the layers constituting the electrode laminate in a desired order. The method of laminating the layers is not particularly limited, and examples thereof include a method in which a negative electrode active material layer, a solid electrolyte layer, and a positive electrode active material layer are formed by powder compaction, and the layers are laminated in a desired order. In addition, there is a method in which a mixture slurry capable of forming the respective layers of the negative electrode active material layer, the solid electrolyte layer, and the positive electrode active material layer is applied to a base material and then dried, and the respective layers are laminated in a desired order. The base material of the negative electrode active material layer may be, for example, a negative electrode current collector layer. The substrate of the solid electrolyte layer may be, for example, a peelable metal foil such as an aluminum foil. The base material of the positive electrode active material layer may be, for example, a positive electrode current collector layer.

The method of providing the current collector terminal is not particularly limited. For example, a method of forming a slit portion by cutting or the like on one surface of a metal material that can be used as a current collector terminal is exemplified.

### Foil Concentrating Section Insertion Process

As illustrated in FIG. 2B, the disclosed methods include inserting a collected foil portion 111a into a slit-portion 120a of a current collector terminal. There is no particular limitation on the method of receiving the foil collecting portion in the slit portion.

### Resistance Welding Electrode Placement Process

As illustrated in FIG. 2C, the disclosed methods include placing resistance welding electrodes 20 on opposite sides of the current collector terminal 120 so as to sandwich the slit-portion 120a. That is, the resistance welding electrodes 20 are arranged on both sides of the current collector terminal 120 so that the front end surface of the resistance welding electrode 20 is parallel to the direction in which the slit-portion 120a extends.

### Resistance Welding Process

As illustrated in FIG. 2C, the disclosed methods include energizing the resistance welding electrode 20 to resistance weld the current collector foil 111 in the slit-portion 120a while pressing the current collector terminal 120 with the resistance welding electrode 20. Incidentally, in FIG. 2C, the white arrows in the upward and downward directions indicate a state in which the current collector terminal is pressed by the resistance welding electrode, and the one arrow in the downward direction indicates a state in which the resistance welding electrode is energized. By joining the current collector terminal and the current collector foil by resistance welding, cutting of the current collector foil can be effectively suppressed. The pressure at the time of pressing, the magnitude of the current at the time of energization, and the like can be appropriately set in view of the depth of the slit-portion 120a, the current collector terminal 120, the current collector foil 111, and the like.

### Electrode Laminate Housing Process

As illustrated in FIG. 2D, the disclosed methods include accommodating an electrode laminate 110 at a current collector terminal 120 and an exterior body 130. As the exterior body 130, a laminate film is exemplified. In this case, the laminate film may be formed by winding the electrode laminate 110 and the current collector terminal 120, and accommodating the electrode laminate 110 together with the current collector terminal 120. In addition, the laminate film may be composed of two films. In this case, the electrode laminate 110 and the current collector terminal 120 may be sandwiched between two films from above and below in the stacking direction of the electrode laminate 110, and the electrode laminate 110 may be accommodated together with the current collector terminal 120.

What is claimed is:

1. A laminated battery comprising:
an electrode laminate;
a current collector terminal; and
an exterior body that houses the electrode laminate together with the current collector terminal, wherein:
a plurality of current collector foils extends from an end face of the electrode laminate; and
the current collector terminal has one slit portion in part of a surface that faces the electrode laminate, all the current collector foils are collected into a collected foil portion, and the collected foil portion is inserted into and joined to the slit portion to electrically connect the electrode laminate to the current collector terminal via the current collector foils.

2. The laminated battery according to claim 1, wherein a depth of the slit portion is 30% or more of a thickness of the current collector terminal.

3. A method for manufacturing the laminated battery according to claim 1, the method comprising:
providing the electrode laminate and the current collector terminal;
inserting the collected foil portion into the slit portion of the current collector terminal;
disposing resistance welding electrodes on both sides of the current collector terminal to sandwich the slit portion;
performing resistance welding on the current collector foils in the slit portion by energizing the resistance welding electrodes while pressing the current collector terminal with the resistance welding electrodes; and
housing the electrode laminate in the current collector terminal and the exterior body.
